(19) United States
(12) Patent Application Publication
(10) Pub. No.: US 2019/0140750 A1
(43) Pub. Date: May 9, 2019

(54) Communication System Employing Downlink Control Information for Interference Cancellation

(71) Applicant: Nokia Solutions and Networks Oy, Espoo (FI)

(72) Inventors: Karol SCHOBER, Helsinki (FR); Mihai ENESCU, Espoo (FI)

(21) Appl. No.: 16/099,787

(22) PCT Filed: May 12, 2016
(86) PCT No.: PCT/EP2016/060695

§ 371 Date: Nov. 8, 2018

(51) Int. Cl. H04B 15/02; H04B 7/0456; H04W 72/04; H04W 72/08; H04L 5/00; H04L 1/00; H04B 7/0452

(52) U.S. Cl. CPC H04B 15/02; H04B 7/0456; H04W 72/042; H04L 1/0038; H04L 5/0023; H04L 1/0048; H04B 7/0452; H04W 72/082

(57) ABSTRACT

There is provided a method including receiving, at a first near apparatus, first control information including downlink control information relating to the first near apparatus and a first pointer; wherein the pointer is configured to indicate where, in a common second control information, downlink control information may be found for at least one far/paired second apparatus associated with that first near apparatus; receiving, at the first near apparatus, second common control information including downlink control information relating to the at least one far/paired second apparatus; and using the first pointer to extract downlink control information from the second control information relating to a specific apparatus of the at least one far/paired second apparatus.

### FIELD

The present application relates to a method, apparatus, system and computer program.

### BACKGROUND

A communication system can be seen as a facility that enables communication sessions between two or more entities such as user terminals, base stations and/or other nodes by providing carriers between the various entities involved in the communications path. A communication system can be provided for example by means of a communication network and one or more compatible communication devices. The communication sessions may comprise, for example, communication of data for carrying communications such as voice, electronic mail (email), text message, multimedia and/or content data and so on. Non-limiting examples of services provided comprise two-way or multi-way calls, data communication or multimedia services and access to a data network system, such as the Internet.

In a wireless communication system at least a part of a communication session between at least two stations occurs over a wireless link. Examples of wireless systems comprise public land mobile networks (PLMN), satellite based communication systems and different wireless local networks, for example wireless local area networks (WLAN). The wireless systems can typically be divided into cells, and are therefore often referred to as cellular systems.

A user can access the communication system by means of an appropriate communication device or terminal. A communication device of a user is often referred to as user equipment (UE). A communication device is provided with an appropriate signal receiving and transmitting apparatus for enabling communications, for example enabling access to a communication network or communications directly with other users. The communication device may access a carrier provided by a station, for example a base station of a cell, and transmit and/or receive communications on the carrier.

The communication system and associated devices typically operate in accordance with a given standard or specification which sets out what the various entities associated with the system are permitted to do and how that should be achieved. Communication protocols and/or parameters which shall be used for the connection are also typically defined. An example of attempts to solve the problems associated with the increased demands for capacity is an architecture that is known as the long-term evolution (LTE) of the Universal Mobile Telecommunications System (UMTS) radio-access technology. LTE is being standardized by the 3rd Generation Partnership Project (3GPP). The various development stages of the 3GPP LTE specifications are referred to as releases. Certain releases of 3GPP LTE (e.g., LTE Rel-11, LTE Rel-12, LTE Rel-13) are targeted towards LTE-Advanced (LTE-A). LTE-A is directed towards extending and optimizing the 3GPP LTE radio access technologies. Another example of a communication system is the 5G concept.

### SUMMARY

According to a first aspect, there is provided a method comprising: receiving, at a first apparatus, first control information comprising downlink control information relating to the first apparatus and a first pointer; receiving, at the first apparatus, second control information comprising downlink control information relating to at least one apparatus; and using the first pointer to extract downlink control information from the second control information relating to a specific apparatus of the at least one apparatus.

The first pointer may be used to extract downlink control information from the second control information relating to multiple apparatus of the at least one apparatus.

The method may further comprise: using, by the first apparatus, the extracted downlink control information to determine parameters for an interference cancellation technique for removing interference resulting from transmissions to the specific apparatus from a network apparatus.

The method may further comprise: using, by the first apparatus, the extracted downlink control information to select an interference cancellation technique for removing interference resulting from transmissions to the specific apparatus from a network apparatus.

The extracted downlink control information may comprise information relating to a power, and/or precoding matrix indicator, and/or modulation order that a network apparatus is using to transmit data to the specific apparatus, and the method may further comprise: cancelling, by the first apparatus, signals from data received by the first apparatus in dependence on at least one of said power, precoding matrix indicator, and modulation order.

The first pointer may be a bitmap.

The method may further comprise: receiving the second control information in a common search space.

The method may further comprise: determining from the extracted downlink control information whether the precoding matrix indicator of the specific apparatus is the same as the precoding matrix indicator of the first apparatus; and when the precoding matrix indicators are the same, selecting an interference cancellation technique to be used for cancelling interference from a received signal.

The method may further comprise: receiving, at a second apparatus, third control information comprising downlink control information relating to the second apparatus and a second pointer; receiving, at the second apparatus, the second control information; and using the second pointer to extract downlink control information relating to another specific apparatus.

According to a second aspect, there is provided an apparatus comprising: at least one processor; and at least one memory comprising computer code that, when executed on the at least one processor, causes the apparatus to: receive first control information comprising downlink control information relating to the first apparatus and a first pointer; receive second control information comprising downlink control information relating to at least one apparatus; and use the first pointer to extract downlink control information from the second control information relating to a specific apparatus of the at least one apparatus.

The first pointer may be used to extract downlink control information from the second control information relating to multiple apparatus of the at least one apparatus.

The apparatus may be further caused to: use the extracted downlink control information to determine transmission parameters to select parameters for an interference cancellation technique for removing interference resulting from transmissions to the specific apparatus from a network apparatus.

The apparatus may be further caused to: use the extracted downlink control information to select an interference cancellation technique for removing interference resulting from transmissions to the specific apparatus from a network apparatus.

The extracted downlink control information comprises information relating to a power, and/or precoding matrix indicator, and/or modulation order that a network apparatus uses to transmit data to the specific apparatus, and the apparatus may be further caused to: cancel signals from data received by the first apparatus in dependence on at least one of said power, precoding matrix indicator, and modulation order.

The first pointer may be a bitmap.

The apparatus may be further caused to: receive the second control information in a common search space.

The apparatus may be further caused to: determine from the extracted downlink control information whether the precoding matrix indicator of the specific apparatus is the same as the precoding matrix indicator of the first apparatus; and when the precoding matrix indicators are the same, select an interference cancellation technique to be used for cancelling interference from a received signal.

According to a third aspect, there is provided an apparatus comprising: means for receiving first control information comprising downlink control information relating to the first apparatus and a first pointer; means for receiving second control information comprising downlink control information relating to at least one apparatus; and means for using the first pointer to extract downlink control information from the second control information relating to a specific apparatus of the at least one apparatus.

The first pointer may be used to extract downlink control information from the second control information relating to multiple apparatus of the at least one apparatus.

The apparatus may further comprise: means for using the extracted downlink control information to determine transmission parameters to select parameters for an interference cancellation technique for removing interference resulting from transmissions to the specific apparatus from a network apparatus.

The apparatus may further comprise: means for using the extracted downlink control information to select an interference cancellation technique for removing interference resulting from transmissions to the specific apparatus from a network apparatus.

The extracted downlink control information may comprise information relating to a power, and/or precoding matrix indicator, and/or modulation order that a network apparatus uses to transmit data to the specific apparatus, and the apparatus may further comprise: means for cancelling signals from data received by the first apparatus in dependence on at least one of said power, precoding matrix indicator, and modulation order.

The first pointer may be a bitmap.

The apparatus may further comprise: means for receiving the second control information in a common search space.

The apparatus may further comprise: means for: determining from the extracted downlink control information whether the precoding matrix indicator of the specific apparatus is the same as the precoding matrix indicator of the first apparatus; and means for selecting, when the precoding matrix indicators are the same, an interference cancellation technique to be used for cancelling interference from a received signal.

According to a fourth aspect, there is provided a system comprising any of the apparatus mentioned above, and further comprising a second apparatus comprising: at least one processor; and at least one memory comprising computer code that, when executed on the at least one processor, causes the second apparatus to: receive third control information comprising downlink control information relating to the second apparatus and a second pointer; receive the second control information; and use the second pointer to extract downlink control information relating to another specific apparatus.

According to a fifth aspect, there is provided a computer program comprising computer executable instructions, which when executed by a computer, cause the computer to perform each of the method steps of any of claims 1 to 9.

In the above, many different embodiments have been described. It should be appreciated that further embodiments may be provided by the combination of any two or more of the embodiments described above.

### DESCRIPTION OF FIGURES

Embodiments will now be described, by way of example only, with reference to the accompanying Figures in which:

FIG. 1 illustrates an example communication system in which the embodiments described below may be implemented;

FIG. 2 illustrates an example user terminal;

FIG. 3 illustrates several examples of providing assistance information;

FIG. 4 illustrates example control information receivable by apparatus; and

FIG. 5 is a flow chart illustrating potential actions undertaken by an apparatus.

### DETAILED DESCRIPTION

The present system relates to a manner for providing an apparatus (such as a user terminal) with downlink control information relating to at least one other apparatus (such as other user terminals). When a signal received by the apparatus comprises messages meant for multiple apparatus that are superposed therein, the provided downlink control information may be used by the apparatus to retrieve a message meant for the apparatus from that received signal using interference cancellation mechanisms that utilise the downlink control information. Example cancellation mechanisms include codeword-interference-cancellation (CWIC), symbol-level-interference cancellation (SLIC) and reduced-maximum-likelihood (RML) cancellation. Such a system has particular application in a non-orthogonal multiple-access (NOMA) system, in which messages meant for different user terminals may be transmitted by a base station (or an equivalent network element) in a superposed manner at the same time and on the same frequency but at different powers.

Particular examples of NOMA systems are detailed below, and include Multi-user superposed transmission (MUST), in which messages meant for different user terminals may also be transmitted by the base station in a superposed manner at the same frequency, and multi-user multiple-input-multiple-output (MU-MIMO) techniques.

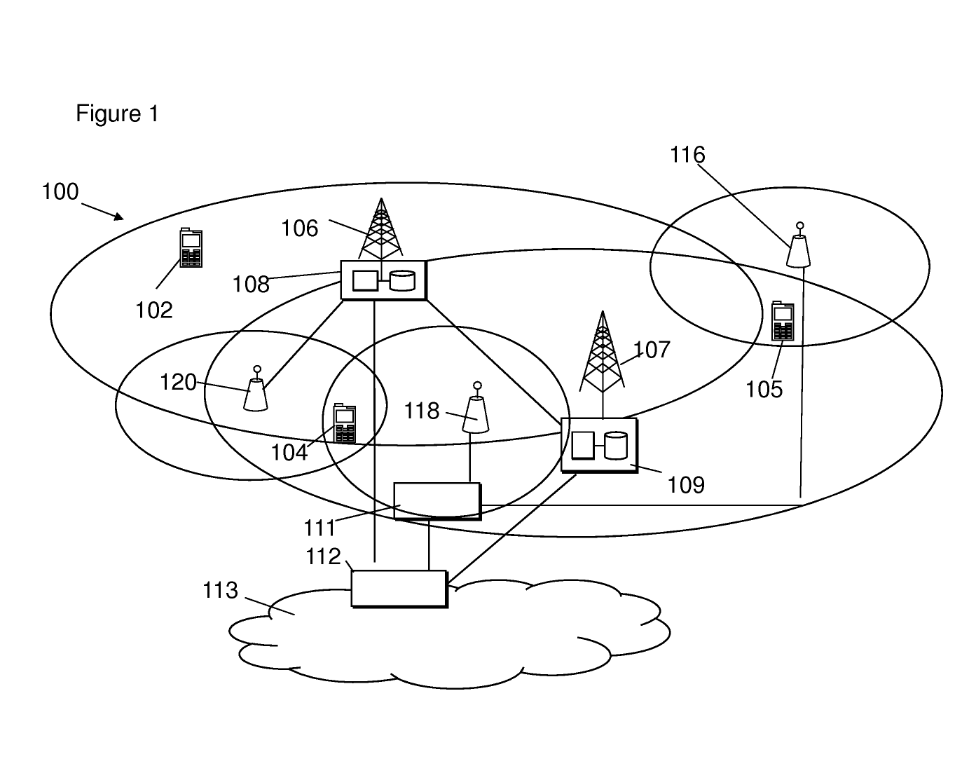

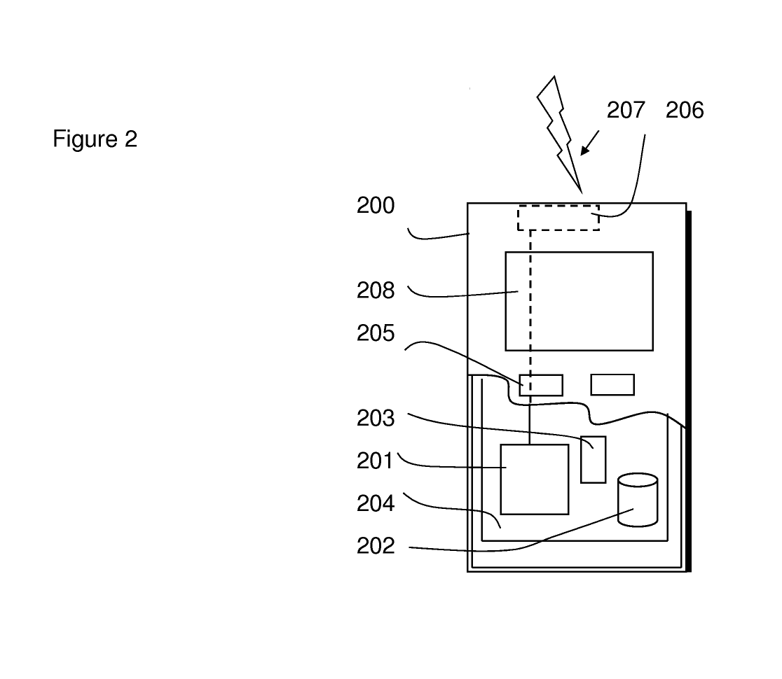

Before explaining in detail the examples, certain general principles of a wireless communication system and mobile communication devices are briefly explained with reference to FIGS. 1 to 2 to assist in understanding the technology underlying the described examples.

In a wireless communication system 100, such as that shown in FIG. 1, mobile communication devices or user terminal 102, 104, 105 are provided wireless access via at least one base station or similar wireless transmitting and/or receiving node or point. Base stations are typically controlled by at least one appropriate controller apparatus, so as to enable operation thereof and management of mobile communication devices in communication with the base stations. The controller apparatus may be located in a radio access network (e.g. wireless communication system 100) or in a core network (CN) (not shown) and may be implemented as one central apparatus or its functionality may be distributed over several apparatus. The controller apparatus may be part of the base station and/or provided by a separate entity such as a Radio Network Controller. In FIG. 1 control apparatus 108 and 109 are shown to control the respective macro level base stations 106 and 107. The control apparatus of a base station can be interconnected with other control entities. The control apparatus is typically provided with memory capacity and at least one data processor. The control apparatus and functions may be distributed between a plurality of control units. In some systems, the control apparatus may additionally or alternatively be provided in a radio network controller.

LTE systems may however be considered to have a so-called “flat” architecture, without the provision of RNCs; rather the (e)NB is in communication with a system architecture evolution gateway (SAE-GW) and a mobility management entity (MME), which entities may also be pooled meaning that a plurality of these nodes may serve a plurality (set) of (e)NBs. Each user terminal is served by only one MME and/or S-GW at a time and the (e)NB keeps track of current association. SAE-GW is a “high-level” user plane core network element in LTE, which may consist of the S-GW and the P-GW (serving gateway and packet data network gateway, respectively). The functionalities of the S-GW and P-GW are separated and they are not required to be co-located.

In FIG. 1 base stations 106 and 107 are shown as connected to a wider communications network 113 via gateway 112. A further gateway function may be provided to connect to another network.

The smaller base stations 116, 118 and 120 may also be connected to the network 113, for example by a separate gateway function and/or via the controllers of the macro level stations. The base stations 116, 118 and 120 may be pico or femto level base stations or the like. In the example, stations 116 and 118 are connected via a gateway 111 whilst station 120 connects via the controller apparatus 108. In some embodiments, the smaller stations may not be provided. Smaller base stations 116, 118 and 120 may be part of a second network, for example WLAN and may be WLAN APs.

A possible mobile communication device will now be described in more detail with reference to FIG. 2 showing a schematic, partially sectioned view of a communication device 200. Such a communication device is often referred to as user equipment (UE) or terminal. An appropriate mobile communication device may be provided by any device capable of sending and receiving radio signals. Non-limiting examples comprise a mobile station (MS) or mobile device such as a mobile phone or what is known as a ‘smart phone’, a computer provided with a wireless interface card or other wireless interface facility (e.g., USB dongle), personal data assistant (PDA) or a tablet provided with wireless communication capabilities, or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts and other information.

The mobile device 200 may receive signals over an air or radio interface 207 via appropriate apparatus for receiving and may transmit signals via appropriate apparatus for transmitting radio signals. In FIG. 2 transceiver apparatus is designated schematically by block 206. The transceiver apparatus 206 may be provided for example by means of a radio part and associated antenna arrangement. The antenna arrangement may be arranged internally or externally to the mobile device.

A mobile device is typically provided with at least one data processing entity 201, at least one memory 202 and other possible components 203 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 204. The user may control the operation of the mobile device by means of a suitable user interface such as key pad 205, voice commands, touch sensitive screen or pad, combinations thereof or the like. A display 208, a speaker and a microphone can be also provided. Furthermore, a mobile communication device may comprise appropriate connectors (either wired or wireless) to other devices and/or for connecting external accessories, for example hands-free equipment, thereto.

The communication devices 102, 104, 105 may access the communication system based on various access techniques, such as code division multiple access (CDMA), or wideband CDMA (WCDMA). Other non-limiting examples comprise time division multiple access (TDMA), frequency division multiple access (FDMA) and various schemes thereof such as the interleaved frequency division multiple access (IFDMA), single carrier frequency division multiple access (SC-FDMA) and orthogonal frequency division multiple access (OFDMA), space division multiple access (SDMA) and so on. Signalling mechanisms and procedures, which may enable a device to address in-device coexistence (IDC) issues caused by multiple transceivers, may be provided with help from the LTE network. The multiple transceivers may be configured for providing radio access to different radio technologies.

An example of wireless communication systems are architectures standardized by the 3rd Generation Partnership Project (3GPP). A latest 3GPP based development is often referred to as the long term evolution (LTE) of the Universal Mobile Telecommunications System (UMTS) radio-access technology. The various development stages of the 3GPP specifications are referred to as releases. More recent developments of the LTE are often referred to as LTE Advanced (LTE-A). The LTE employs a mobile architecture known as the Evolved Universal Terrestrial Radio Access Network (E-UTRAN). Base stations of such systems are known as evolved or enhanced Node Bs (eNBs) and provide E-UTRAN features such as user plane Packet Data Convergence/Radio Link Control/Medium Access Control/Physical layer protocol (PDCP/RLC/MAC/PHY) and control plane Radio Resource Control (RRC) protocol terminations towards the communication devices. Other examples of radio access system comprise those provided by base stations of systems that are based on technologies such as wireless local area network (WLAN) and/or WiMax (Worldwide Interoperability for Microwave Access). A base station can provide coverage for an entire cell or similar radio service area.

Another example of a suitable communications system is the 5G concept. Network architecture in 5G may be quite similar to that of the LTE-advanced. Changes to the network architecture may depend on the need to support various radio technologies and finer QoS support, and some on-demand requirements for e.g. QoS levels to support QoE of user point of view. Also network aware services and applications, and service and application aware networks may bring changes to the architecture. Those are related to Information Centric Network (ICN) and User-Centric Content Delivery Network (UC-CDN) approaches. 5G may use multiple input-multiple output (MIMO) antennas, many more base stations or nodes than the LTE (a so-called small cell concept), including macro sites operating in co-operation with smaller stations and perhaps also employing a variety of radio technologies for better coverage and enhanced data rates.

It should be appreciated that future networks may utilise network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations to be carried out, at least partly, in a server, host or node operationally coupled to a remote radio head. It is also possible that node operations will be distributed among a plurality of servers, nodes or hosts. It should also be understood that the distribution of labour between core network operations may vary between systems in accordance with the operating protocol and the exact implementation of the system.

As mentioned above, the present system has particular application in a NOMA system (although it is understood that the described techniques are not limited to such a system). A NOMA system is one in which multiple access is enabled using the power domain. Multi-user superposed transmission (MUST) is a downlink version of a NOMA system. MUST has been approved by 3GPP for use in future systems (see 3GPP RP-160680).

As an example of MUST, a scenario in which two apparatus served by a single base station is considered. In this system, the two apparatus are both assigned the same time, precoding matrix and frequency for receiving a transmission from the base station. However, the apparatus are each assigned different respective power levels for receiving messages meant for them from the base station. In other words, messages meant for one of the apparatus is transmitted at a first power whilst messages meant for the other apparatus is transmitted at a second power, where the first and second powers are different to each other. The base station is therefore configured to send data as a superposed transmission of a message for one apparatus at a higher power level than a message for the other apparatus, whilst still keeping the time, spatial precoder/beam and frequency of the transmitted data the same for both messages.

In the proposed MUST system for 3GPP, two apparatus associated with the same cell are “paired”. In this context, the term “paired” denotes those apparatus that are configured to receive downlink transmissions on the same frequency, and at the same time as each other. This term thus covers both when NOMA is applied to a Multi-user MIMO system (in which at least two apparatus are not constrained to also receive downlink transmissions on the same spatial precoder) and to a MUST system (in which at least two apparatus are constrained to receive downlink transmissions on the same spatial precoder. This latter case may also be described as the two apparatus having the same beam/precoder matrix identifier as each other). It is understood that the techniques described herein are not limited to those systems in which only two apparatus are “paired”. For clarity throughout the following and the above, the described system will consider the more restrictive MUST case. However, it is understood that the presently described techniques also apply to the more general MU-MIMO case, and that references to “near” and “far” apparatus also cover those situations in which the apparatus below are merely “paired” as per the above.

Each apparatus has an associated quality metric that is representative of quality of the channel between the base station and that apparatus. Example quality metrics include Channel State Information (CSI), Channel Quality Indicator (CQI) and a signal to interference and noise ratio (SINR). The apparatus having the lower quality (as determined from the associated quality metric) is assigned a higher transmission power than the apparatus having the higher quality. The power assignment may be performed by, for example, the serving base station that will be making the superposed transmissions. By assigning the apparatus having the poorer quality (the “far” apparatus) a higher transmission power, downlink superposed transmissions received by that far apparatus may be treated by the far apparatus as though messages meant for other users are merely noise. Such a treatment allows the far apparatus to extract messages meant for itself on the downlink. Further, the apparatus assigned the lower transmission power (the “near” apparatus) can obtain information regarding the transmission power of the other apparatus and use this information to obtain its own message. One way of doing this is by cancelling the higher power transmission from the received superposed signal (for example, using symbol-level interference cancellation techniques).

Efficient use of such a MUST system is achieved when the quality metrics are very different from each other. This normally leads to sets of paired apparatus in which one apparatus is much closer to the transmitting/serving base station (the “near” apparatus assigned the lower power in a downlink transmission) than the other apparatus (the “far” apparatus assigned the higher power in a downlink transmission). Throughout the following, the term “near” apparatus will be used to denote the apparatus having the lower assigned power in a group of apparatus. The term “far” apparatus will be used to denote the apparatus having the higher assigned power in a group of apparatus.

Depending on the interference mitigation scheme employed by the near apparatus (and/or the type of NOMA scheme used), the near apparatus does not need to decode the message for the far apparatus in order to cancel/suppress the interference from the message for the far apparatus. Therefore, in some cases, details such as the modulation and coding scheme and/or the redundancy version (i.e. which code is being used for redundancy transmissions) is not required for interference suppression. Some knowledge is, however, required to perform certain interference suppression techniques, depending on the exact techniques employed. For example, knowledge of interfering power, and/or modulation order and/or the precoding matrix indicator (PMI) of far/paired apparatus may be useful. Furthermore, the near apparatus may need to know on which parts of its allocated downlink channel the interference from the far apparatus is present. For clarity, in relation to the far apparatus, the term “assistance information” will be used in the following to denote the information required by the near apparatus in order to cancel some of the message for the far apparatus from the near apparatus's received data.

There are at least two ways in which the near apparatus may determine assistance information. In the first case, the near apparatus may use blind detection e.g. blind detection of the far apparatus's: PMI, power offset, interference presence, modulation order, etc. In the second case, the near apparatus may rely on dynamic signalling of the assistance information from the base station to the far apparatus. This latter case is discussed in R1-162494 and R1-162562.

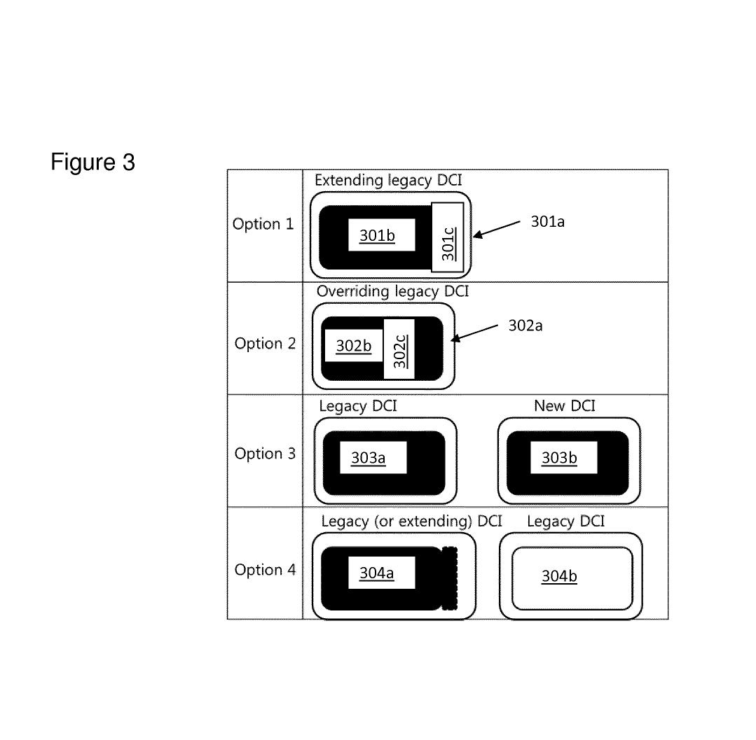

R1-162494 presents 4 different options for dynamically signalling the downlink control information. These are illustrated in the following with respect to FIG. 3.

In the first option (shown at 301 in FIG. 3), a near apparatus decodes a single control information element 301a comprising both assistance information 301b for the far apparatus and downlink control information/scheduling information 301c for the near apparatus. The single control information element 301a is formed by extending the existing/legacy downlink control information for the near user equipment with assistance information. The inventors have realised that such a system would typically only be useful for only one paired apparatus.

In the second option, a near apparatus decodes a single control information element 302a containing both assistance information 302b and near apparatus's downlink control information 302c. The single control information element 302a is formed by replacing at least one field of the existing/legacy downlink control information for the near user equipment with assistance information. As in the case of option 1, the inventors have realised that such a system would typically only be useful for only one paired apparatus.

In the third option, a near apparatus decodes its own legacy downlink control information 303a and a new downlink control information 303b containing the assistance information.

In the fourth option 4, a near apparatus decodes its own legacy downlink control information 304a (and/or an extended version as per option 1) and overhears the far apparatus's existing/legacy downlink control information element 304b. For LTE-based systems, the inventors have realised that this option requires a blind detection search on the user specific search space (defined in 3GPP as being a channel space in which an apparatus is configured to search for a data transmission for itself) for the far apparatus, in addition to knowledge of the Radio Network Temporary Identifier (RNTI) of the far apparatus.

After identifying the above-mentioned issues, the inventors have therefore determined to provide a mechanism based on the third option. The mechanism is directed towards providing for scheduling flexibility, keeping complexity at the apparatus low, keeping overhead for transmissions low, and enabling dynamic switching between MUST (same beam pairing), advanced MU-MIMO (different beam pairing) and SU-MIMO.

In the following, there is described an apparatus (such as a near apparatus) that is configured to obtain downlink control information relating to another apparatus. The downlink control information may be used by the apparatus to perform interference mitigation techniques.

To this effect, there is provided a first apparatus (as described above) configured to receive first control information comprising downlink control information relating to the first apparatus and a first pointer. The first control information may be received from a network element, such as a network element providing access to a telecommunications network. The first pointer may be, for example, a bitmap or some other mechanism for identifying a particular part of received data. The first apparatus is also configured to receive second control information comprising downlink control information relating to at least one apparatus (for example, to a far apparatus or to a paired apparatus). The second control information may also be received from the network element. The second control information may comprise downlink control information relating to only one other apparatus or downlink control information The first apparatus is configured to use the first pointer (received with the first apparatus' own downlink control information) to extract relevant downlink control information from the second control information relating to a specific apparatus of the at least one apparatus. The extracted information may be used to perform interference cancellation on a latter received signal. Example cancellation mechanisms include codeword-interference-cancellation (CWIC), symbol-level-interference cancellation (SLIC) and reduced-maximum-likelihood (RML) cancellation. Of these, SLIC and RML cancellation are considered to have particular use in the NOMA system.

This mechanism is similar to the third option described above, bar the control information element of the first apparatus contains a bitmap (or the like) pointing to a location in a new common control information element/downlink control information of assistance information for at least one other apparatus associated and/or paired with the first apparatus. This new control information element/downlink control information is common to all near apparatus (i.e. apparatus within a predetermined area may be configured to receive the new common control information element and to extract assistance information regarding their associated pair apparatus therefrom). In one example, the common control information element comprises assistance information about all scheduled far apparatus layers (power levels, modulation orders, PM's, etc.) in that cell in that particular subframe.

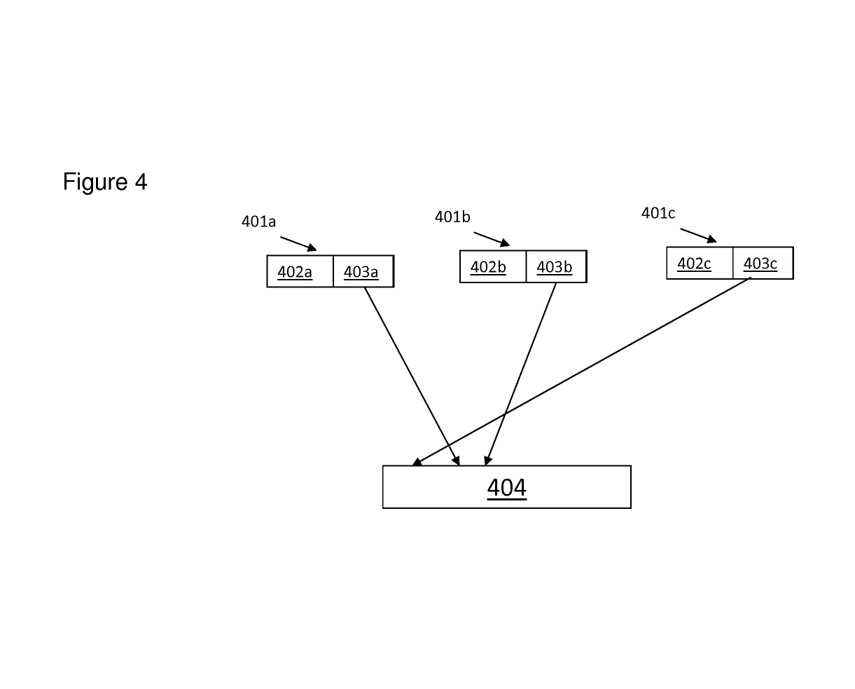

This described mechanism is illustrated with respect to FIG. 4. In FIG. 4, there is shown three control information elements for near apparatus (401a to 401c). Each of these three control information elements comprises respective downlink control information (402a to 402c) for a respective near apparatus, and a respective pointer (403a to 403c). Each near apparatus is configured to receive a respective control information element (401a to 401c). Each near apparatus may be configured to only receive/decode a control information element comprising that near apparatus's downlink control information. The pointer (403a to 403c) in each control information element is configured to indicate where, in a common control information 404, downlink control information may be found for the at least one far/paired apparatus associated with that near apparatus. The pointer may indicate a subset of far/paired apparatus, as each apparatus may be paired with more than one other apparatus (depending on the scheme employed). The pointer may indicate only one far/paired apparatus to the near apparatus.

The above-described mechanism can significantly lower the complexity of a receiver of an apparatus relative to those receivers that have to perform network-assisted interference cancellation and suppression (NAICS)-type blind detection because the presently described near apparatus may perform interference presence blind detection given fewer variables of downlink communication parameters used by the network element for the at least one far apparatus. This significantly reduces blind detection complexity and increases reliability in blind detection.

As mentioned above, the presently disclosed system relates to a manner for providing an apparatus (such as a user terminal) with downlink control information relating to at least one other apparatus (such as other user terminals). When a signal received by the apparatus comprises messages meant for multiple apparatus that are superposed therein, the provided downlink control information may be used by the apparatus to retrieve a message meant for the apparatus from that received signal using interference cancellation mechanisms that utilise the downlink control information.

To this effect, there is provided a first apparatus configured to receive first control information comprising downlink control information relating to the first apparatus and a first pointer. The first control information may be received from a network element, such as a network element providing access to a telecommunications network (e.g., a base station or eNB). The downlink control information relating to the first apparatus may comprise scheduling information relating to downlink transmissions to be made to the first apparatus. The first pointer may be, for example, a bitmap or some other mechanism for identifying a particular part of network assistance information.

The first apparatus is also configured to receive second control information comprising downlink control information relating to at least one apparatus (for example, to a far user terminal or to a paired user terminal, which are later described hereunder). The second control information may further comprise information relating to apparatus that is neither paired with nor considered a far apparatus to the first apparatus. In other words, the second control information may further comprise information relating to at least one apparatus that is operating at a different time and/or frequency and/or spatial resource to the first apparatus. The second control information may also be received from the network element. The second control information may comprise downlink control information relating to only one other apparatus or downlink control information relating to multiple other apparatus. The first apparatus is configured to use the first pointer (received with the first apparatus' own downlink control information) to extract relevant downlink control information from the second control information relating to a specific apparatus of the at least one apparatus. This downlink control information may be used by the first apparatus to employ interference suppression techniques for retrieving a message meant for the first apparatus from a received signal in which messages for multiple users are superposed (e.g. in a NOMA system).

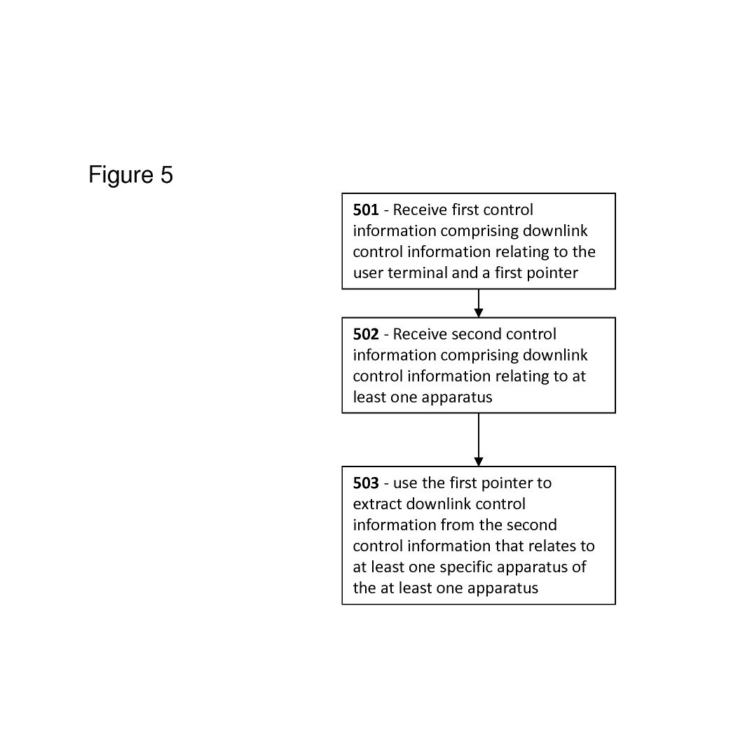

The operations of the above-mentioned first apparatus are described in relation to FIG. 5.

At 501, the apparatus is configured to receive first control information comprising downlink control information relating to the apparatus and a first pointer. The first control information may be received from a network element, such as a base station and/or some other type of access point to a communications network. This downlink control information may comprise scheduling information relating to the apparatus.

At 502, the apparatus is configured to receive second control information comprising downlink control information relating to at least one apparatus. The second control information may also be received from the network element. The at least one apparatus is a different apparatus to the receiving apparatus, the at least one apparatus may be a single apparatus or multiple apparatus. The at least one apparatus may be another user terminal or multiple user terminals. The second downlink control information may comprise multiple downlink control information relating to respective apparatus. By this, it is meant that each of the multiple downlink control information relates to a respective apparatus.

At 503, the apparatus is configured to use the first pointer to extract downlink control information from the second control information that relates to at least one specific apparatus of the at least one apparatus. The pointer may be a bitmap, and/or some other mechanism for identifying a location of data within a received signal. The extracted control information may be considered to be relevant control information in the sense that it is information that is useable by the apparatus for determining how to remove a superposed signal meant for another apparatus from a received signal,

The apparatus may be further configured to use the extracted downlink control information to determine transmission parameters for suppressing potential interference resulting from transmissions of the specific apparatus. For example, the apparatus may determine the powers at which downlink transmissions were (or are scheduled to be) made from a network element to each of the apparatus and the specific at least one apparatus, and to use this determined power to cancel interfering signals from a received data signal that arise from the downlink transmission to the at least one specific apparatus.

The extracted downlink control information may comprise information relating to the power at which the specific apparatus receives data. For example, the received information may define a power offset at which the network element transmits data to the specific apparatus. The first apparatus may be further configured to cancel signals from data received by the first apparatus in dependence on said power.

The apparatus may be further configured to associate the specific apparatus with the apparatus prior to receiving the first control information. This association may be initiated following a communication from a network element (such as a base station) that indicates another apparatus with which the first apparatus has been paired. The meaning of paired in this context is described further below.

The apparatus may be further configured to determine from the extracted downlink control information whether the precoding matrix indicator of the specific apparatus is the same as the precoding matrix indicator of the apparatus. When the precoding matrix indicators are the same, the apparatus may know which interference cancellation technique to employ, for example using single-layer RML assuming Gray-labelled super-constellation (MUST) or two-layer RML using super-constellation which is not Gray-labelled (MU-MIMO). This operation will allow for dynamic pairing, e.g. pairing where allocations and pairing-schemes of paired apparatus do not necessarily align.

In the system comprising the apparatus, there may be provided a second apparatus (such as a second user terminal). The second apparatus may be configured to receive third control information comprising downlink control information relating to the second apparatus and a second pointer. The second apparatus may further receive the second control information (i.e. receive common control information/downlink control information). The second apparatus may be configured to use the second pointer to extract downlink control information relating to another specific apparatus. In other words, the second pointer identifies at least one different apparatus to the at least one apparatus identified by the first apparatus.

The presently described techniques may be applied to apparatus employing NOMA techniques, such as MUST and/or MU-MIMO with a non-linear receiver.

The common control information element may contain the resource allocation of all the apparatus served by the network element (e.g. both those far and near apparatus). However, the resource allocation is large per apparatus (typically 11-25 bits per apparatus). Therefore, it is very unlikely that a network element, such as an eNB, would signal the entire resource allocation of the far-UEs to the near apparatus, as this would add to the control overhead of the system.

The common downlink control information may contain small fixed amount of bits describing each far apparatus layer, for example 7 bits. Thus a network element could provide assistance information for up to 6 paired apparatus layers with 42 bits downlink control information, without also providing the radio network temporary identifier and/or cyclic redundancy information of the far apparatus.

These 7 bits could carry following information about each paired apparatus layer. For the above-mentioned MUST system, the assistance information may comprise 2 bits for information on Closed-loop demodulation reference signal/Closed-loop cell-specific reference signal/transmission diversity/large delay-cyclic delay diversity operation; 2 bits for information on the precoding matrix identifier/the precoding matrix identifier cycling offset/the port used for the demodulation reference signal; 2 bits for the modulation order (this is not needed if the far apparatus is restricted in its modulation type); and 1 bit for the power offset relative to the near user equipment or to the reference signal power. From the precoding matrix identifier/the port used for the demodulation reference signal, the near apparatus knows whether interfering paired apparatus layer is MUST (same PMI as the near apparatus) or MU-MIMO (different PMI than the near apparatus).

When the near apparatus obtains the bitmap of paired-layers in its own received control information, and finds some bits being 1 (or otherwise indicating that there are paired/far apparatus to that near apparatus), the near apparatus will attempt to decode the second common control information containing the paired/far downlink control information. This common control information can be preconfigured at the specific control channel elements in at least one of the user specific search space and the common search space.

Such an arrangement would therefore reduce the need for modifications to the near apparatus blind detection behaviour, which keeps the complexity low (and therefore cost) of a receiver of such a near user equipment. Upon successful detection, the apparatus creates one interference presence hypothesis for each indicated paired apparatus layer and hypothesis about no interference. The apparatus performs per physical resource block (PRB)-pair (or PRB group) interference presence/type detection and performs interference cancellation/detection of own signal correspondingly.

It is noted that while the above describes example embodiments, there are several variations and modifications which may be made to the disclosed solution without departing from the scope of the present invention.

The above describes near and far apparatus. This terminology is commonly employed when discussing paired MUST apparatus. However, it is understood that the techniques described above using this terminology also apply in other scenarios, such as MU-MIMO, in which the far apparatus is termed a paired apparatus and the near apparatus is termed a primary apparatus.

For clarity, throughout the following, reference to the apparatus receiving the superposed signal is referred to as either an apparatus or as a user terminal. However, it is understood that the presently described techniques are not limited to cases in which the apparatus is a user terminal or the like. Instead, the present disclosure may apply to any case in which NOMA transmissions are made to multiple apparatus.

In general, the various embodiments may be implemented in hardware or special purpose circuits, software, logic or any combination thereof. Some aspects of the invention may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The foregoing description has provided by way of non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims. Indeed there is a further embodiment comprising a combination of one or more embodiments with any of the other embodiments previously discussed.

1. A method comprising:
receiving, at a first apparatus, first control information comprising downlink control information relating to the first apparatus and a first pointer;
receiving, at the first apparatus, second control information comprising downlink control information relating to at least one apparatus; and
using the first pointer to extract downlink control information from the second control information relating to a specific apparatus of the at least one apparatus.

2. A method as claimed in claim 1, wherein the first pointer may be used to extract downlink control information from the second control information relating to multiple apparatus of the at least one apparatus.

3. A method as claimed in claim 1, further comprising:
using, by the first apparatus, the extracted downlink control information to determine parameters for an interference cancellation technique for removing interference resulting from transmissions to the specific apparatus from a network apparatus.

4. A method as claimed in claim 1, further comprising:
using, by the first apparatus, the extracted downlink control information to select an interference cancellation technique for removing interference resulting from transmissions to the specific apparatus from a network apparatus.

5. A method as claimed in claim 1, wherein the extracted downlink control information comprises information relating to a power, and/or precoding matrix indicator, and/or modulation order that a network apparatus is using to transmit data to the specific apparatus, and the method further comprises:
cancelling, by the first apparatus, signals from data received by the first apparatus in dependence on at least one of said power, precoding matrix indicator, and modulation order.

6. A method as claimed in claim 1, wherein the first pointer is a bitmap.

7. A method as claimed in claim 1, further comprising:
receiving the second control information in a common search space.

8. A method as claimed in claim 1, further comprising:
determining from the extracted downlink control information whether the precoding matrix indicator of the specific apparatus is the same as the precoding matrix indicator of the first apparatus; and
when the precoding matrix indicators are the same, selecting an interference cancellation technique to be used for cancelling interference from a received signal.

9. A method as claimed in claim 1, further comprising:
receiving, at a second apparatus, third control information comprising downlink control information relating to the second apparatus and a second pointer;
receiving, at the second apparatus, the second control information; and
using the second pointer to extract downlink control information relating to another specific apparatus.

10. An apparatus comprising:
at least one processor; and
at least one memory comprising computer code that, when executed on the at least one processor, causes the apparatus to:
receive first control information comprising downlink control information relating to the first apparatus and a first pointer;
receive second control information comprising downlink control information relating to at least one apparatus; and
use the first pointer to extract downlink control information from the second control information relating to a specific apparatus of the at least one apparatus.

11. An apparatus as claimed in claim 10, wherein the first pointer may be used to extract downlink control information from the second control information relating to multiple apparatus of the at least one apparatus.

12. An apparatus as claimed in claim 10, wherein the apparatus is further caused to:
use the extracted downlink control information to determine transmission parameters to select parameters for an interference cancellation technique for removing interference resulting from transmissions to the specific apparatus from a network apparatus.

13. An apparatus as claimed in claim 10, wherein the apparatus is further caused to use the extracted downlink control information to select an interference cancellation technique for removing interference resulting from transmissions to the specific apparatus from a network apparatus.

14. An apparatus as claimed in claim 10, wherein the extracted downlink control information comprises information relating to a power, and/or precoding matrix indicator, and/or modulation order that a network apparatus uses to transmit data to the specific apparatus, and the apparatus is further caused to:
cancel signals from data received by the first apparatus independence on at least one of said power, precoding matrix indicator, and modulation order.

15. An apparatus as claimed in claim 10, wherein the first pointer is a bitmap.

16. An apparatus as claimed in claim 10, wherein the apparatus is further caused to:
receive the second control information in a common search space.

17. An apparatus as claimed in claim 10, wherein the apparatus is further caused to:
determine from the extracted downlink control information whether the precoding matrix indicator of the specific apparatus is the same as the precoding matrix indicator of the first apparatus; and
when the precoding matrix indicators are the same, select an interference cancellation technique to be used for cancelling interference from a received signal.

18. A system comprising the apparatus of claim 10, and further comprising a second apparatus comprising:
at least one processor; and
at least one memory comprising computer code that, when executed on the at least one processor, causes the second apparatus to:
receive third control information comprising downlink control information relating to the second apparatus and a second pointer;
receive the second control information; and
use the second pointer to extract downlink control information relating to another specific apparatus.

19. A computer program comprising computer executable instructions, which when executed by a computer, cause the computer to perform the method steps of claim 1.
